(19) United States
(12) Patent Application Publication
(10) Pub. No.: US 2006/0050149 A1
(43) Pub. Date: Mar. 9, 2006

(54) Mobile wireless camera system

(76) Inventors: Heinrich Lang, Ergersheim (DE); Harald Emmert, Bad Windsheim (DE); Hermann Kiesenbauer, Ergersheim (DE); Michael Witzke, Ansbach (DE)

Correspondence Address: MCNAIR LAW FIRM, P.A., P.O. BOX 10827, GREENVILLE, SC, 29603-0827, US

(21) Appl. No.: 11/126,641

(22) Filed: May 11, 2005

(30) Foreign Application Priority Data
Sep. 8, 2004 (DE) 202004013984.7

(51) Int. Cl. H04N 7/18; H04N 9/47

(52) U.S. Cl. 348/148

(57) ABSTRACT

A mobile wireless camera system for commercial vehicles allowing the driver of the commercial vehicle to see areas surrounding the commercial vehicle using first and second cameras connected to first and second camera transceivers for capturing images and transmitting a first and second image signals representing the captured images. The system uses a controller in communication with a control transceiver for setting an ID code in each camera and for selecting a camera for viewing. The camera transceivers transmit the ID code along with the image signals. The controller uses an ID code recognition unit for identifying whether the ID code is the ID code of the selected camera. The controllers allows transmission of images if the received ID code and the ID code of the selected camera are the same.

### FIELD OF THE INVENTION

The present invention relates to a mobile camera system with wireless signal transmission, in particular for utility vehicles, as well as a process for such a system.

### BACKGROUND

Camera systems are often used for monitoring areas that are difficult or impossible to see. The German patent application bearing file number 10234483.3 discloses a video camera at the rear of a truck for the monitoring of the rear area. A monitor enables the driver, as he drives in reverse, to approach loading ramps in reverse and to recognize obstacles behind the vehicle in time. Similarly, cameras can be used to monitor so-called “blind spots” or areas in front of the vehicle.

The image signals of the camera are transmitted by means of continuous data conduits, in particular metal or glass fiber cables. These are not only expensive to install, in particular when retrofitting existing vehicles, but are also prone to damage. Especially in the case of utility vehicles with trailers that can be uncoupled, the data conduit must be detachable. The plug required for this constitutes another weak point prone to damage or disturbance and raises the cost of the system.

For example, EP 1 273 478 A1 discloses image signals of cameras that can be transmitted in a wireless manner over electromagnetic waves, i.e. in form of radio signals. Control signals for the camera (switching it on and off, swiveling, focusing, etc.) can also use wireless transmission.

In that case, however, other radio signals may interfere with the image and/or control signals of the camera system. Thus, if several cameras are installed on a utility vehicle and transmit or receive their image or control signals on the same transmission channel, a malfunction occurs.

### SUMMARY OF THE INVENTION

A camera system according to the invention comprises at least one camera for the recording and wireless transmission of image signals on a transmission channel as well as a controller to receive and display the image signals from the camera.

The controller assigns a unique ID code to the camera and has a first identification unit for the release of the image signals only in case that an ID code transmitted together with the image signals matches the one assigned to the camera. The camera has a storage unit to store the assigned ID code. The camera then transmits this ID code together with the image signals.

Upon actuation of the camera, the controller assigns it a unique ID code, e.g. an identification number, a name, an identification signal etc. This is stored in the camera and is transmitted to the controller together with its image signals.

In the controller, the first identification unit recognizes whether the ID code received together with the image signals matches the one assigned to the camera from which the image signals are to be received. Only if this is the case is the transmission released and the image signals can be displayed at the controller on an associated monitor.

If another camera transmits image signals on the transmission channel, this is recognized by the first identification unit as an error. The error occurs as the wrong ID code is transmitted together with the image signals. Then, an error message may be issued; the system may be switched off or the camera may be switched over to another transmission channel.

### DESCRIPTION OF THE DRAWINGS

FIG. 1 is a perspective view illustrating a truck with a camera system according to an embodiment of the present invention, and

FIG. 2 is a block diagram illustrating components of the present invention.

### DETAILED DESCRIPTION OF AN EMBODIMENT

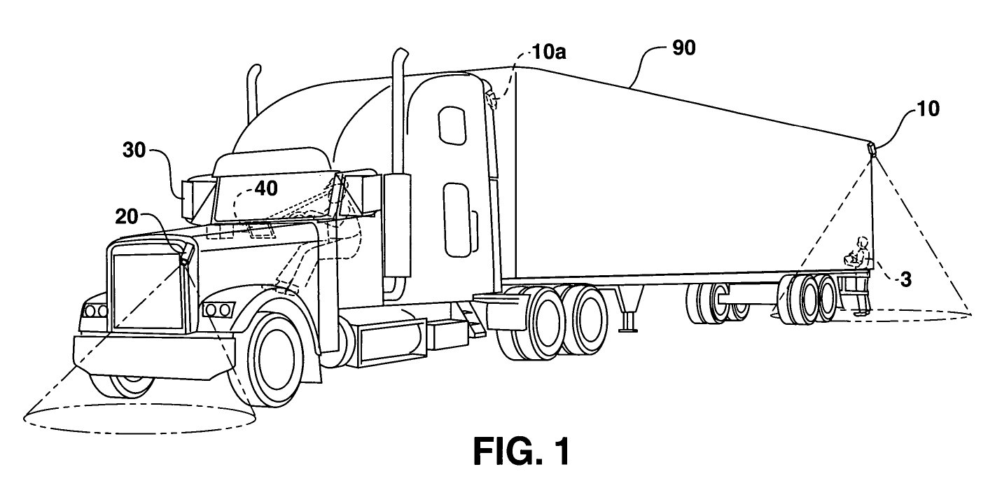

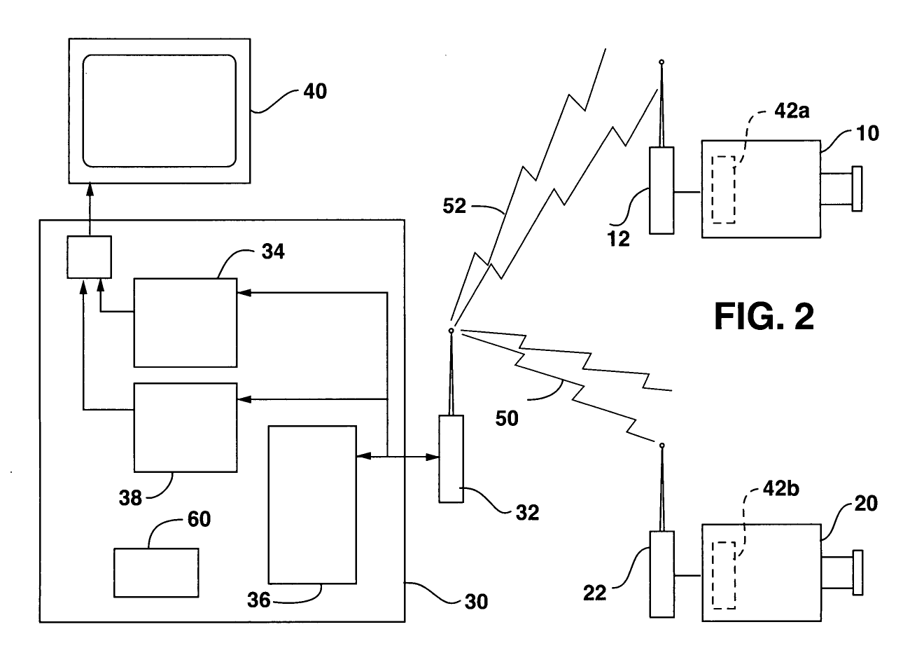

A mobile wireless camera system for commercial vehicles allowing the driver of the commercial vehicle to see areas surrounding the commercial vehicle is shown in FIGS. 1 and 2. Similarly, the camera system can also be used with agricultural utility vehicles, construction machines etc. A camera system according to the invention can also be used for the monitoring of processes or areas in industry, in the home or for leisure activities. The embodiment represented here shows only one example of an application.

A first camera 10 is connected to a first camera transceiver 12 for capturing images and transmitting a first image signal representing the captured images. Camera 10 can be attached to the associated commercial vehicle 90 by a quick-mounting device. Suitable quick-mounting devices may include bayonet or snap-on connections, magnetic holders or screw connections.

Further, the first camera 10 can also be installed by means of the quick-mounting device on the top of the driver cab shown as 10a in FIG. 1. This makes it possible to monitor the rear area of the truck even when the trailer is uncoupled. The camera system also includes a charging station in which cameras 10 and 20 can be received for charging the camera.

In order to function, the cameras of the system must be actuated. This may be done by releasing the energy supply of the utility vehicle by actuating an ignition switch. Similarly, a camera can be actuated through the recognition of a given monitoring situation. For example, the system can recognize when the truck is placed in reverse. The rear area behind the truck should be monitored in this situation. Thus, the system actuates camera 10.

A second camera 20 for the monitoring of the area directly in front of the truck and not directly visible by the driver is provided in addition on the truck 90. This camera can also be attached by means of the quick-mounting device described above. Alternatively, the first camera 10 can also be provided as second camera during travel operation and can be moved and installed in the position shown in FIG. 1 by means of the quick-mounting device before placing the truck in reverse. A second camera 20 is connected to a second camera transceiver 22 for capturing images and transmitting a second image signal representing the captured images.

A control transceiver 32 is included in the cab for receiving signals from first and second camera transmitters 12 and 22 representing images captured by first and second cameras 10 and 20.

A controller 30 is in communication with control transceiver 32. Monitor 40 is in communication with the controller 30. It is installed in the driver cab of the truck within sight of the driver. The images recorded by the camera can be displayed on the monitor 40. Controller 30 sets an ID code in each camera and selects a camera for viewing. Upon actuation an assigning unit 36 in the controller 30 sets an ID code which is objectively unique for each actuated camera. The ID code is preferably an identification number, for example the reference number shown in FIG. 1. This ID code is stored in each camera. Once the ID code is set in the camera, camera transceivers 12 and 22 transmit the ID code along with the image signals to the control transceiver 32. The cameras record images and send corresponding image signals via a transmission channel 50 or 52 to the controller 30. The transmission channel can be assigned to each camera together with the ID Code at actuation or can be assigned later.

The system uses first and second transmission channels 50 and 52 for transmitting ID codes, images and control signals via the camera and control transceivers. The camera transmits its ID code together with the image signal or periodically at predetermined time intervals. Similarly, the camera can transmit the ID code quasi-continuously by means of multiplex processes. The controller includes an ID code recognition unit 34 for identifying whether the ID code received by the controller is the ID code of the selected camera. Controller 30 then allows transmission of images if the received ID code and the ID code of the selected camera match. Thus, the images recorded by the camera can be displayed on monitor 40.

If the ID code received does not match the one assigned by the assigning unit to the selected camera, the first identification unit recognizes that the transmission of the image signals is not correct. The controller 30 changes the transmission channel of the transmitting camera if the received ID code does not match the ID code set at the selected camera. The controller 30 transmits a control signal to the camera changing its transmission channel. Similarly, the first identification unit can also report the erroneous transmission and interrupt the transmission.

Further, the controller can also transmit control signals to the camera in order to start or end the recording and transmission of images, to change the field of vision of the camera by swiveling, zooming, etc., or to perform other tasks. To ensure that only the selected camera processes the received control signals, the controller can transmit the ID code of the selected camera together with the control signal to the selected camera. A second identification unit 42a and 42b in each camera recognizes whether the control signals are intended for that camera. Only if this is the case does the camera react to the control signals.

In normal operation of the vehicle, controller 30 receives the image signals transmitted by camera 20 through control transceiver 32. The first identification unit recognizes the ID code transmitted with the image signals that they originate from only the proper camera 20. Thus, the proper images from camera 20 are released to be displayed on monitor 40 during normal travel operation without any error.

When shifting into reverse, camera 10 should transmit image signals so that the rear vehicle area may be monitored. For this purpose a control signal is transmitted together with the camera's ID code by the controller 30 over the first control signal transmission channel 52. The camera 10 receives the control signal. Its second identification unit recognizes from ID code that the control signal is intended for the camera. Thus, camera 10 begins transmitting image signals together with their ID code over the first transmission channel 52.

Camera 20 may also receive the control signal together with the ID code over the first transmission channel. Its second identification unit recognizes that the control signal is not intended for the camera and therefore does not act on the control signal. Camera 20 also transmits over the first image signal transmission channel 52 during travel.

Now camera 10 as well as camera 20 are transmitting over the first image transmission channel and the image signals are therefore disturbed and not suitable for the display of the camera's image. The first identification unit in controller 30 recognizes that the wrong ID code is being transmitted over the first transmission channel, together with the image signals. If the controller recognizes that a wrong ID code is being transmitted over the first transmission channel (i.e. by camera 20 while only camera 10 should transmit) said controller transmits to camera 10 (not 20) over the first control signal transmission channel to switch over to the second transmission channel. Since interference or other disturbances are not necessarily generated by a second camera (but also for example radio transmissions or the like) it is more effective to address the camera from which transmission signals are awaited by the controller.

After the switch, controller 30 recognizes that the transmission originates at the correct camera and is not disturbed by any other camera. It therefore releases the transmission, and during reverse travel the images of the camera 10 representing obstacle 3 behind the truck are displayed.

The camera systems according to the invention therefore ensures that only the image or control signals from or for the selected camera are transmitted over an image and/or control signal transmission channel.

In a further embodiment of the present invention the cameras are first installed in a charging station 60 which is preferably in proximity of the controller 30. When they are not in use, cameras can advantageously be charged at the charging station to ensure the energy supply of the cameras. In a further embodiment, a camera is activated by de-installing from the charging station.

Additionally, interference recognition device 38 may be included in the controller to recognize whether an image or control signal is being disturbed by other transmitters without ID codes. Such an interference recognition device may recognize from the intensity of the signal received or from the frequencies contained therein whether the signal is being disturbed by other signals. In this case too, the transmission channel can be changed, thus maintaining the display of the proper image signal. It thus ensures faultless transmission that is not disturbed by other transmitters.

What is claimed:

1. A mobile wireless camera system for commercial vehicles allowing the driver of the commercial vehicle to see areas surrounding the commercial vehicle comprising:
a first camera connected to a first camera transceiver for capturing images and transmitting a first image signal representing the captured images;
a second camera connected to a second camera transceiver for capturing images and transmitting a second image signal representing the captured images;
a control transceiver for receiving said first and second image signals from said first and second camera transceivers;
a controller in communication with said control transceiver for setting an ID code in each camera and for selecting one of said first and second cameras for viewing;
said camera transceivers adapted for transmitting said ID codes with said image signals to said controller through said control transceiver; and
said controller identifying whether the ID code received by said controller is the ID code of the camera selected for viewing and allowing transmission of images if the received ID code and the ID code of the selected camera are the same.

2. The system of claim 1 further comprising an ID code recognition unit for identifying whether the ID code received by said controller is the ID code of the camera selected for viewing and allowing transmission of images if the received ID code and the ID code of the selected camera are the same.

3. The system of claim 1 further comprising:
first and second transmission channels for transmitting ID codes, images and control signals via said camera and control transceivers;
wherein said controller changes the transmission channel of the transmitting camera if the transmitted ID code does not match the selected camera ID code.

4. The system of claim 1 further comprising:
a monitor in communication with said controller for displaying the transmitted image.

5. The camera system of claim 1, wherein at least one camera can be attached to an associated commercial vehicle by a quick-mounting device.

6. The camera system of claim 1 further comprising:
a charging station in which a camera is received for charging the power supply camera.

7. A mobile wireless camera system comprising:
a camera for recording images;
a camera transceiver for wirelessly transmitting an image signal representing the recorded images over a transmission channel;
a control transceiver for receiving the image signals from said camera;
a controller in communication with said control transceiver for setting a unique ID code in said camera;
said camera having a storage unit to store the assigned ID code;
said camera transceiver for transmitting the ID code together with the image signals; and
a first identification unit included in said controller for determining if the ID code transmitted together with the image signals matches the assigned ID code.

8. The camera system of claim 7 further comprising:
a second camera for recording images; and
a second camera transceiver for wirelessly transmitting image signals.

9. The camera system of claim 7 further comprising:
a second identification unit carried by said camera for recognizing whether an ID code transmitted together with a control signal matches the assigned ID code for said camera; and
wherein said controller is for transmitting control signals along with the ID code to the said camera.

10. The camera system of claim 7 wherein said camera transceiver transmits the ID code continuously with the image signal.

11. The camera system of claim 7 further comprising:
an interference recognition device carried by said controller to recognize interference with the image signal by other signals.

12. A method for wirelessly transmitting video signals in a camera system having a plurality of cameras and a controller comprising the steps of:
assigning a unique ID code to at least one camera by a controller;
transmitting said ID code together with image signals from the camera to the controller;
comparing a received ID code to said ID code assigned to the camera; and
releasing the image signals for display if the ID codes match.

13. The method of claim 12 further comprising the steps of:
indicating a malfunction if the ID codes do not match; and
changing the transmission channel of the camera transmitting the incorrect ID codes.
